(19) United States
(12) Patent Application Publication
(10) Pub. No.: US 2025/0037010 A1
(43) Pub. Date: Jan. 30, 2025

(54) MACHINE LEARNING-BASED USER INTENT DETERMINATION

(71) Applicant: HOME DEPOT INTERNATIONAL, INC., Atlanta, GA (US)

(72) Inventors: Michael Ellis, Rogers, AZ (US); Resham Lal Jagadheesh, Alpharetta, GA (US); Nian Yan, Dunwoody, GA (US)

(21) Appl. No.: 18/285,816

(22) PCT Filed: Oct. 4, 2023
(86) PCT No.: PCT/US23/75983

§ 371 Date: Oct. 5, 2023

Related U.S. Application Data
(60) Provisional application No. 63/413,068, filed on Oct. 4, 2022.
(60) Provisional application No. 63/526,738, filed on Jul. 14, 2023.

(51) Int. Cl. G06N 20/00; G06F 40/30

(52) U.S. Cl. CPC G06N 20/00; G06F 40/30

(57) ABSTRACT

A method of determining a user intent from a predefined set of user intents includes receiving user-generated text through an electronic user interface, such as a website, and generating first embeddings representative of the user-generated text. The method further includes calculating a respective individual intent score for each of a plurality of training phrases, each individual intent score calculated according to a similarity of the first embeddings to second embeddings, representative of a respective training phrase of the plurality of training phrases, wherein each training phrase is associated with an intent of a predefined set of user intents, outputting, to the user in response to the user-generated text, a plurality of user intents according to the respective individual intent scores, receiving, from the user, a selection of one of the plurality of user intents, and classifying, according to the selection, a user intent for the user-generated text.

### TECHNICAL FIELD

This disclosure generally relates to intent detection in user text, such as user text entered in a chat program or other communication.

### BACKGROUND

Certain user text in chat and messaging is difficult for known natural language understanding approaches to understand. For example, tail queries, which are longer in length and include multi-word phrases with lower rates of occurrence, are common and typically difficult for known systems to understand.

### BRIEF DESCRIPTION OF THE DRAWINGS

FIG. 1 is a block diagram illustrating an example process for receiving user input text and determining an intent of the user input text.

FIG. 2 is a block diagram view of an example system for determining a user intent of input text.

FIG. 3 is a flow chart illustrating an example method of processing user input text.

FIGS. 4A and 4B are flow charts illustrating an example method of processing user input text.

FIG. 5 is a diagrammatic view of an example embodiment of a user computing environment.

### DETAILED DESCRIPTION

Known natural language understanding (“NLU”) programs generally do not understand many tail queries with a high rate of accuracy. This problem is particularly present in applications in which real-time understanding and response to such tail queries are important, such as in chat programs and other programs for real-time automated communications with users. In such applications, the complex processing that known approaches would take to user intent classification for tail queries take too long to process to be viable.

The instant disclosure improves upon known approaches for user intent understanding in tail queries and other user-generated text by comparing complex user input text to previous user inputs with known intent classifications and classifying the complex user input text based on the known intent classifications of the closest-matching previous user inputs. Such comparisons requires significantly fewer computing resources than the complex processing typically performed by NLU systems, and thus enables intent detection and corresponding responses to the user in real time for robust automated communications with the user.

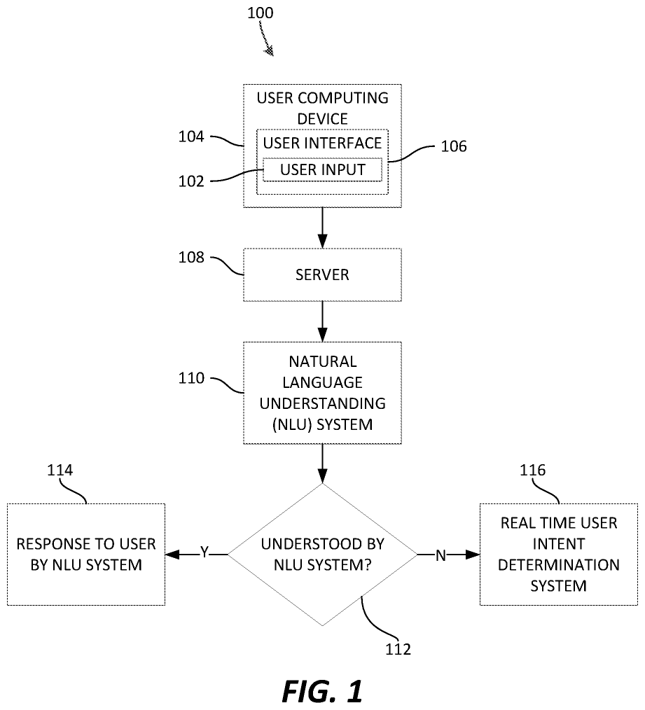

Referring now to the drawings, wherein like numerals refer to the same or similar features in the various views, FIG. 1 is a block diagram illustrating an example process 100 for receiving user input text and determining an intent of the user input text. The process 100 may include a user entering user input text 102 through a user computing device 104. The user input text may be entered through an electronic user interface 106 provided on the user computing device 104.

The electronic user interface 106 may be or may include a chat program interface or other communications interface through which the user may enter text input 102 and through which responsive information may be provided to the user. The electronic user interface 106 may be or may include a website through which a user may access information about items (e.g., products and services), make purchases, etc. Accordingly, the user's input text 102 may relate to information on the website (e.g., one or more items, categories of items, a search query for a particular item or feature(s) of items), the user's prior interactions with the website (e.g., the user's previous orders, the status of a currently pending order, search history, etc.), troubleshooting an item listed on the website, details of potential interactions or transactions with the website, and the like.

The user computing device 104 may be in communication with a server 108 that may provide data for (e.g., host) the electronic user interface 106 through which the user enters the user input 102. The user input 102 may therefore be transmitted by the user computing device 104 to the server 108, and from the server 108 to a natural language understanding (“NLU”) system 110. The NLU system 110 may perform complex processing on the user input 102 to determine the user's intent and to provide a corresponding response through the server 108 and electronic user interface 106 on the user computing device 104. For example, the NLU system 110 may attempt to determine if the user's intent is to locate a document, get information about a current order, troubleshoot an item listed on the website, search for an item, determine item availability, report an issue with a current or past order, modify or cancel a current order, return an item, how to perform a particular type of interaction or transaction (e.g., a discounted transaction), etc.

If, at block 112, the user input 102 is understood by the NLU system 110, the NLU system may determine and output a response to the user, at block 114, through the server 108 and the electronic user interface 106. But if, at block 112, the user input 102 is not understood by the NLU system 110, then the user input 102 may be provided to a novel real time user intent determination system 116 (which may be referred to herein as the “intent determination system 116”) for further processing. The user intent determination system 116 may determine the user's intent in the user input 102 that could not be understood by the NLU system 110 and, based on that user intent, either the NLU system 110 or another system may determine and output a response to the user input 102 through the electronic user interface 106.

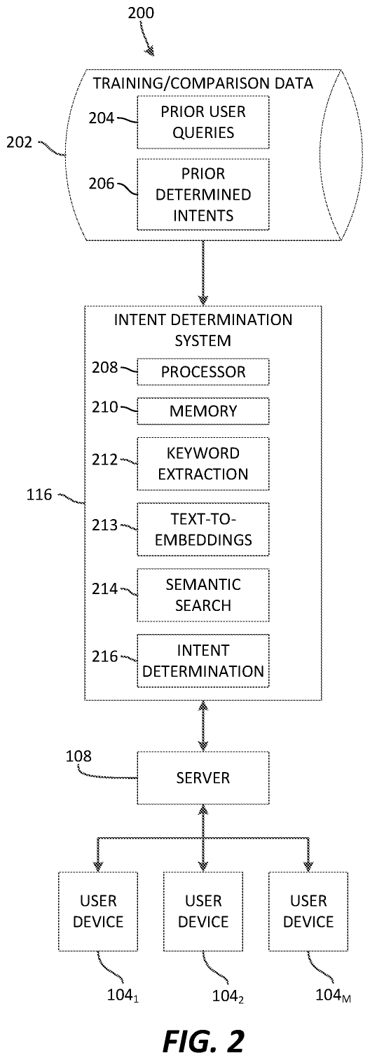

FIG. 2 is a block diagram view of an example system 200 for determining a user intent of input text. The system 200 may include a database 202 or other source of training and comparison data, the intent determination system 116, and the server 108 providing the electronic user interface 106 (shown in FIG. 1) for one or more user input devices 1041, 1042, 104M.

The training and comparison data may include a set of prior user queries 204 and associated prior determined intent classifications 206. Each prior user query in the prior user queries 204 may have a single respective prior determined intent classification in the prior determined intent classifications 206, in some embodiments. In other embodiments, some or all of the prior user queries 204 may have two or more respective prior determined intent classifications.

Each prior user query in the prior user queries 204 may be or may include a query in the form of user-generated text. The text may have been entered by the user(s) through an electronic user interface (e.g., website) supported by the server 108, such as the user interface 106 (shown in FIG. 1). The associated prior user intent classifications 206 may have been determined by a natural language understanding system, such as the NLU system 110 (also shown in FIG. 1).

The intent determination system 116 may include a processor 208 and a non-transitory, computer-readable memory 210 storing instructions that, when executed by the processor 208, cause the intent determination system 116 to perform one or more operations, processes, methods, etc. of this disclosure. The intent determination system may include one or more functional modules 212, 213, 214, 216, which may be embodied as instructions in the memory 210, for example. The processor 208 may be or may include one or more graphical processing units (GPUs) and/or one or more central processing units, in some embodiments. Implementation with one or more GPUs may result in faster performance than with CPUs, in some embodiments, thereby contributing to the real-time benefits of the disclosure discussed herein.

The modules 212, 213, 214, 216 may include a keyword extraction module 212 which may receive, as input, user-entered text and may output one or more keywords extracted from that text. The keyword extraction module 212 may include or may use a Bidirectional Encoder Representations for Transformers (BERT)-based tool, such as KeyBERT in some embodiments. Additionally or alternatively, the keyword extraction module 212 may be or may include YAKE! and/or RAKE, for example. In some embodiments, the one or more keywords may be output as a phrase. Additionally or alternatively, the one or more keywords may be output as individual tokens.

A text-to-embeddings module 213 may receive, as input, a text phrase and output an embeddings vector representative of that input text, which embeddings vector may be the input to the keyword extraction module 212. The text-to-embeddings sub-module may be or may include, for example, a BERT-based (Bidirectional Encoder Representations from Transformers) tool, such as DistilBERT, in some embodiments. The output of the keyword extraction module 212 may similarly be converted to an embeddings vector by the text-to-embeddings sub-module for further processing, as described below.

The modules 212, 213, 214, 216 may further include a semantic search module 214. The semantic search module 214 may receive, as input, a plurality of embeddings vectors representative of respective phrases, and may determine the similarity of the phrases to one another according to the similarity of the vectors. For example, the semantic search module may perform a k-Nearest Neighbors search respective of one or more of the phrases to determine the most similar other phrases. In some embodiments, the Nearest Neighbors search may be or may include an Approximate Nearest Neighbors approach. In some embodiments, the semantic search module may determine the most similar phrases to a phrase output by the keyword extraction module 212 (e.g., the one or more keywords representative of text input by the user). In some embodiments, the semantic search module 214 may determine the most similar phrases of the prior user queries 204 to the text input by the user. For example, the semantic search module may determine the k most similar phrases, where k is a predetermined quantity. Additionally or alternatively, the semantic search module 214 may return one or more nearest neighbors that are more similar than a predetermined similarity threshold.

The modules 212, 214, 216 may further include an intent determination module 216 which may receive, as input, the plurality of determined most similar phrases to the user input phrase and, based on those most similar phrases, determine an intent classification for the user input text. As noted above, each of the most similar phrases may be associated with a determined user intent from the prior user intent classifications 206. For example, the intent determination module 216 may determine the prior user intent classification having the highest quantity of occurrence in the most similar phrases, and may assign that intent classification as the user intent of the user query. For example, if the semantic search module 214 returned ten most similar prior user queries, in which four of the prior user queries were associated with the determined intent of “order history”, three were associated with the determined intent of “existing order”, and three were associated with “issue with order”, the intent determination module 216 may conclude that the user input has an intent of “order history.” In some embodiments, if two or more prior intent classifications tie as having the highest quantity, the prior intent classification associated with the most similar prior user query may be assigned as the intent classification for the current user-generated text. Alternatively, the prior intent classification associated with the highest average similarity of the most similar prior user queries may be assigned as the intent classification for the current user-generated text.

The system 200 may take an appropriate action based on the user intent determined by the intent determination module 216. For example, the server 108 may automatically navigate the user to a page associated with the determined intent, or may output a hyperlink to such a page. In another example, the server 108 may facilitate a connection between the user computing device 104 and a particular system or user service representative. In another example, the server 108 may populate the interface with information related to the user intent, such as current or previous search results, a list of previous searches, a list of previous order, the content of a current or a previous order, and the like.

The system 200 advantageously enables real-time determination of user intent for complex queries that traditionally are not well-understood by NLU systems. The intent determination system 116 leverages previously-determined intent classifications (e.g., from the NLU system 110) associated with previous user queries for comparison with a current user query. That comparison is computationally less demanding than the complex processing that NLU system typically perform on complex queries, enabling real-time intent determination for user queries and corresponding system response.

Further, in some embodiments, the system 200 may train one or more machine learning tools or models. For example, the system may train the keyword extraction module 212 and text-to-embeddings sub-module using the training/comparison data 202. As a result, the data pairs (of prior user queries 204 and paired prior determined intents 206) used to train the intent determination system 116 may be the same, or some of the same, data pairs as the data pairs used as comparison points by the semantic search module 214, in some embodiments.

From the perspective of the user interacting with the electronic user interface, the transition from intent and responses determined by the NLU system 110 to intent and/or responses determined by the intent determination system 116 may be opaque and seamless. That is, the interface and response speed presented to the user may be substantially the same for user-entered text parsed by the NLU system as for user-entered text parsed by the intent determination system 116, in some embodiments.

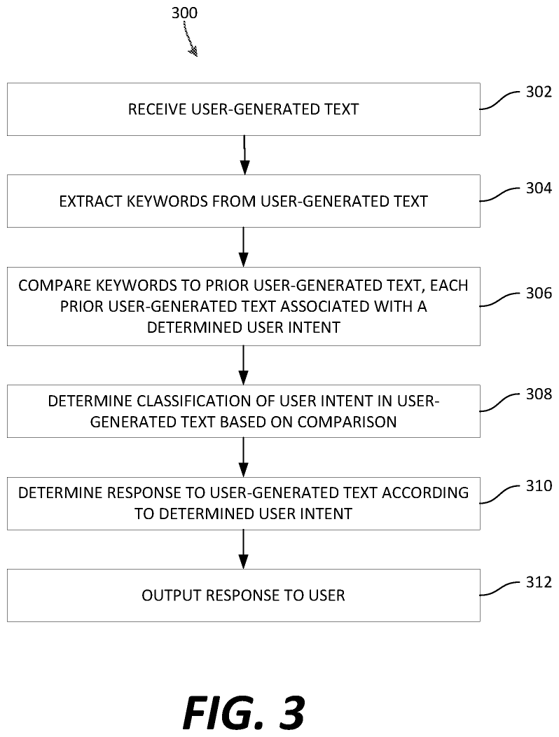

FIG. 3 is a flow chart illustrating an example method 300 of processing user input text. The method 300, or one or more portions of the method 300, may be performed by the intent determination system 116 (shown in FIGS. 1 and 2), in some embodiments, and/or by a server 108 associated with the intent determination system 116.

The method 300 may include, at block 302, receiving user-generated text. The user-generated text may be received through an electronic user interface, such as a portion of a website. In some embodiments, the user-generated text may have been received through a particular communications channel in the interface, such as an automated chat module, for example. The communication channel through which the user text is received may be one in which the user has an expectation of real-time response from the system. The user-generated text received at block 302 may be text that an NLU system cannot understand in real time according to known approaches.

The method 300 may further include, at block 304, extracting one or more keywords from the user-generated text. Extracting the keywords may include calculating an embeddings vector respective of the user-generated text and inputting the embeddings vector into a keyword extraction machine learning tool, which may output a phrase of keywords. Accordingly, block 304 may include calculating embeddings respective of the user generated text, and using a transformer-based machine learning tool, determining the keywords based on the embeddings. Additionally or alternatively, the keyword extraction machine learning tool may output one or more tokens (e.g., with each extracted keyword represented by a word token). The keyword phrase may be converted into a keyword embeddings vector at block 304, in some embodiments.

The method 300 may further include, at block 306, comparing the one or more keywords to a data set, the data set including a plurality of data pairs, each data pair comprising respective prior text and a respective user intent classification, to determine a set of user intent data points. The prior text may be a plurality of prior user inquiries entered through the same or a similar user interface as the interface through which the user-generated text was received at block 302. Further, the prior text may have been submitted by users different from the user from which the user-generated text was received at block 302. The user intent classifications may have been determined by an NLU system. The data pairs in the data set may have been used to train one or more tools used in the method 300, such as the keyword extraction tool and/or text-to-embeddings tool used at block 304.

Comparing the keywords to the dataset at block 306 may include determining a respective distance from an embeddings vector of the keywords to each of a plurality of embeddings vectors associated with each prior text data point and determining a set of the closest prior text data points according to the calculated distances. A predetermined quantity of closest prior text data points may be determined. Additionally or alternatively, closest prior text data points that are within a predetermined distance threshold of (e.g., that are within a predetermined similarity threshold of) the user-generated text.

The method 300 may further include, at block 308, determining, according to the set of user intent data points, a user intent classification associated with the user-generated text. Block 308 may include, for example, determining a respective quantity of each of one or more user intent classifications in the set of user intent data points determined at block 306, and designating a user intent classification of the one or more user intent classifications in the set of user intent data points having a highest quantity of the respective quantities as the user intent classification associated with the user-generated text. Additionally or alternatively, block 308 may include calculating an average similarity, by associated intent classification, of the prior user text of the most similar data points determined at block 306, and designating the intent associated with the lowest average distance as the intent of the current received user-entered text.

The method 300 may further include, at block 310, determining a response to the user-generated text according to the intent determined at block 308. Block 310 may include, for example, locating one or more user order identified in the user text (e.g., where the determined user intent is “current order”, “order history”, etc.), executing a search using a search engine associated with the electronic user interface (e.g., where the user intent is “search”), locating one or more particular items (e.g., where the user intent is for a particular item or for a category of items), etc.

In some embodiments, determining a response at block 310 may be performed by the intent detection system 116. Alternatively, block 310 may include the intent determination system 116 providing the determined intent to the NLU system 110 for the NLU system 110 to determine an appropriate response, based on that intent, according to the processing of the NLU system 110.

The method 300 may further include, at block 312, outputting the determined response to the user from which the user-generated text was received. As noted above, the determined response may be output via a hyperlink to a page containing the responsive information, by automatically navigating the user to a page containing the responsive information, by outputting a textual answer to the user's question, by outputting text of one or more orders, etc. In some embodiments, the determined response may be output to the user substantially in real time following the user's text to which the response is responsive. In some embodiments, the determined response may be output in a chat module or other electronic user interface portion in which the user entered the text to which the response is responsive.

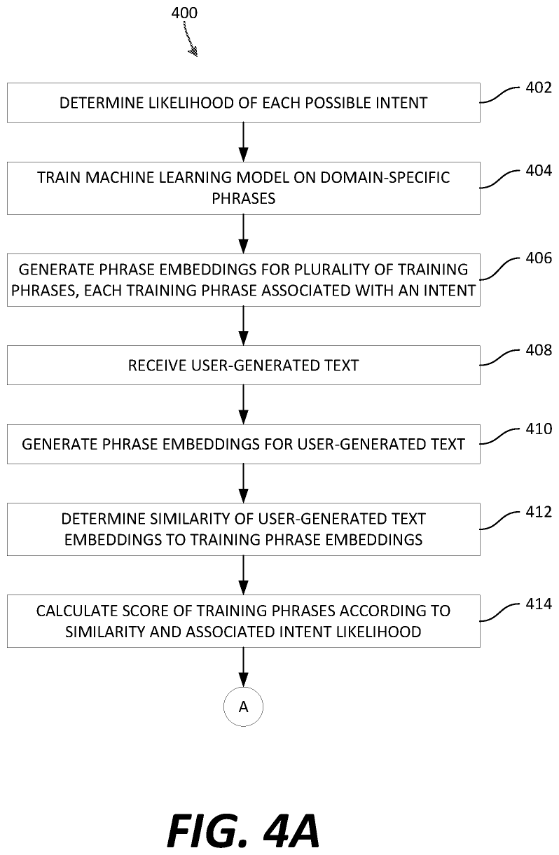

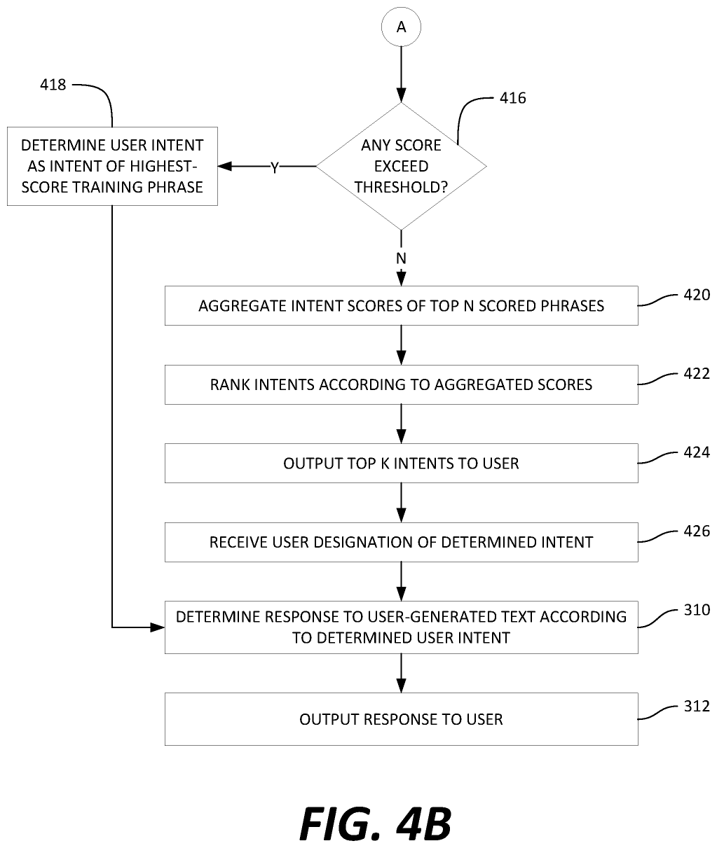

FIGS. 4A and 4B are flow charts illustrating an example method 400 of processing user input text. The method 400, or one or more portions of the method 400, may be performed by the intent determination system 116 (shown in FIGS. 1 and 2), in some embodiments, and/or by a server 108 associated with the intent determination system 116.

Referring to FIG. 4A, the method 400 may include, at block 402, determining a likelihood of each of a plurality of possible user intents. Block 402 may include, for example, calculating the rate of occurrence of each of the possible user intents based on user-generated text through a given interface. For example, if a dataset includes 1,000 instances of user-generated text and ten possible user intent classifications, each of the ten intents may be assigned a probability based on the number of occurrences of that intent within the 1,000 instances. The possible user intents considered at block 402 may be or may include a predefined set of prior determined user intents (e.g., prior determined intents 206), in some embodiments.

In some embodiments, block 402 may include determining likelihoods according to user information. Referring again to the example above, each of the 1,000 data points may be associated with a particular user that generated the text, and each such user may be associated with respective user information, such as an experience level (professional, amateur, etc.), recent user activity (e.g., did or did not access a certain interface portion), etc. Additionally or alternatively, block 402 may include determining likelihoods according to a seasonality, day of week, time of day, or otherwise according to a temporal fact of the user-generated text. Additionally or alternatively, block 402 may include determining likelihoods according to location (e.g., user location at the time of the user-generated text, a location of a recent user visit to a physical location, etc.). Block 402 may include generating one or more lookup tables or algorithms to determine a likelihood for a particular intent given particular input.

The method 400 may further include, at block 404, training a machine learning model according to a set of domain-specific phrases. Each domain-specific phrase may be paired with a known intent associated with the phrase. Accordingly, block 404 may include training a machine learning model on a set of training data pairs, each pair including a phrase and an intent. The model may be or may include, for example, one or more models described above with respect to the text-to-embeddings module 213. The domain-specific phrases may be or may include user-generated text received through a particular electronic user interface (e.g., electronic user interface 106).

The method 400 may further include, at block 406, generating respective phrase embeddings for each of a plurality of training phrases, where each training phrase is associated with a known intent. The phrase embeddings may be generated by inputting each training phrase into the trained model resulting from block 404. The known intent may be based on a known past user action following the user input of the training phrase. Based on block 402, each training phrase intent may be associated with a likelihood.

The method 400 may further include, at block 408, receiving user-generated text. Block 408 may be substantially similar to block 302, in some embodiments.

The method 400 may further include, at block 410, generating phrase embeddings for the user-generated text received in block 408. Block 410 may include inputting the user-generated text into the trained model resulting from block 404. As a result of blocks 408 and 410, both the user-generated text and a plurality of training phrases may have associated embeddings vectors representative of those phrases and text.

The method 400 may further include, at block 412, determining a respective similarity of the phrase embeddings vector generated at block 410 to each of the training phrase embeddings generated at block 406. Similarity at block 412 may be determined according to any appropriate measurement for determining distance between vectors or other similarity of vectors, such as a cosine similarity, Manhattan distance, etc.

The method 400 may further include, at block 414, calculating a score for each of the training phrases according to the similarities calculated at block 412 and the intent likelihood associated with each training phrase's intent. For example, block 414 may include a simple multiplication of a similarity and a likelihood. In other embodiments, other mathematical combinations of the training phrase's similarity to the user-generated text and its intent likelihood may be used.

In some embodiments, block 414 may include calculating a score for a subset, but not all, of the training phrases for which training phrase embeddings were generated at block 406. For example, the X closest training phrases may have their respective calculated similarities combined with their respective intent likelihoods to generate scores, where X is an integer.

Referring to FIG. 4B, the method 400 may further include, at block 416, determining if any of the scores calculated at block 414 exceed a predetermined single score threshold. If so, then at block 418, the intent associated with the highest-scored training phrase may be determined to be the intent of the user-generated text received at block 408.

If, at block 416, it is determined that none of the training phrase scores exceed the predetermined single score threshold, the method 400 may further include, at block 420, aggregating the calculated intent scores of each of the N top scored training phrases, where N is an integer. Consider an example in which the following top ten training phrases are included:

| Phrase | Intent | Score |
|---|---|---|
| Training Phrase 1 | A | 0.35 |
| Training Phrase 2 | B | 0.34 |
| Training Phrase 3 | C | 0.34 |
| Training Phrase 4 | A | 0.30 |
| Training Phrase 5 | A | 0.27 |
| Training Phrase 6 | C | 0.27 |
| Training Phrase 7 | B | 0.27 |
| Training Phrase 8 | B | 0.22 |
| Training Phrase 9 | B | 0.20 |
| Training Phrase 10 | A | 0.18 |

In some embodiments, block 416 may include summing the scores of each training phrase having intent A, summing the scores of each training phrase having intent B, and summing the scores of each phrase having intent C. In this example, the aggregated score for intent A is (0.35+0.30+0.27+0.18=1.10), the aggregated score for intent B is (0.34+0.27+0.22+0.20=1.03) and the aggregated score for intent C is (0.34+0.27=0.51).

The method 400 may further include, at block 422, ranking the intents according to the aggregated scores calculated at block 420. In the example given above, the ranking may be intent A highest ranked, intent B second highest ranked, and intent C third highest ranked.

In some embodiments, the highest-ranked intent at block 422 may be designated as the user's intent, and the method may proceed to block 310. In other embodiments, the method 400 may further include, at block 424, outputting the top K intents to the user as options, where K is an integer. In some embodiments, block 422 may include comparing the aggregated scores to a predetermined aggregated score threshold and, if an aggregated score exceeds the aggregated score threshold, designating the highest-ranked intent as the user's intent. If no aggregated score exceeds the aggregated score threshold, the method may proceed to block 424. Where an aggregated score threshold is applied, it may be the same as or may be different from the individual score threshold.

At block 424, outputting the top K intents to the user may include outputting, in response to the user-generated text, a prompt that includes the top K intents. For example, the prompt may include prompting text such as “Did you mean . . . ” or “Are you looking for . . . ”, followed by each of the top M intents. In the example given above, K may be two, and intent A and intent B may be offered to the user as intent options.

The method 400 may further include, at block 426, receiving a user designation of the user's determined intent in response to the output of block 424. For example, block 426 may include receiving a user click on or other selection of one of the options that were output at block 424.

The method 400 may further include, blocks 310, 312 that, as noted above, include determining a response to the user-generated text according to the determined intent and outputting the determined response to the user from which the user-generated text was received.

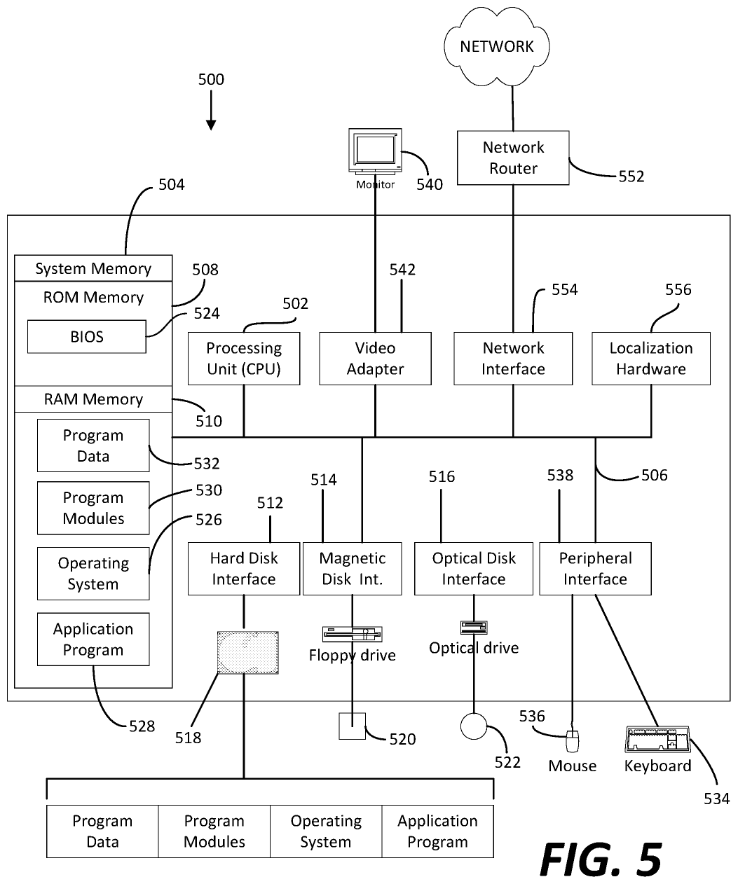

FIG. 5 is a diagrammatic view of an example embodiment of a user computing environment that includes a general purpose computing system environment 500, such as a desktop computer, laptop, smartphone, tablet, or any other such device having the ability to execute instructions, such as those stored within a non-transient, computer-readable medium. Furthermore, while described and illustrated in the context of a single computing system 500, those skilled in the art will also appreciate that the various tasks described hereinafter may be practiced in a distributed environment having multiple computing systems 500 linked via a local or wide-area network in which the executable instructions may be associated with and/or executed by one or more of multiple computing systems 500.

In its most basic configuration, computing system environment 500 typically includes at least one processing unit 502, which may be a GPU or CPU, and at least one memory 504, which may be linked via a bus 506. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard drive 518, and/or peripheral memory devices may be used to store computer executable instructions comprising an operating system 526, one or more applications programs 528 (which may include the functionality of the intent determination system 116 of FIGS. 1-2 or one or more of its functional modules 212, 213, 214, 216, for example), other program modules 530, and/or program data 532. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus 506 via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 552, that is responsible for network routing. Communications with the network router 552 may be performed via a network interface component 554. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 556 for determining a location of the computing system environment 500. In embodiments, the localization hardware 556 may include, for example only, a GPS antenna, an RFID chip or reader, a WiFi antenna, or other computing hardware that may be used to capture or transmit signals that may be used to determine the location of the computing system environment 500.

The computing environment 500, or portions thereof, may comprise one or more components of the system 200 of FIG. 2, in embodiments.

In a first aspect of the present disclosure, a computer-implemented method of determining a user intent from a predefined set of user intents is provided. The method includes receiving, by a computing system, user-generated text, the user-generated text entered by a user through an electronic user interface, generating, by the computing system, first embeddings representative of the user-generated text, calculating, by the computing system, a respective individual intent score for each of a plurality of training phrases, each individual intent score calculated according to a similarity of the first embeddings to second embeddings, representative of a respective training phrase of the plurality of training phrases, wherein each training phrase is associated with an intent of the predefined set of user intents, outputting, to the user in response to the user-generated text, a plurality of user intents according to the respective individual intent scores, receiving, from the user, a selection of one of the plurality of user intents; and classifying, according to the selection, a user intent for the user-generated text.

In an embodiment of the first aspect, the method further includes determining, by the computing system, a respective likelihood of each intent of the predefined set of user intents, wherein calculating the respective intent score for each training phrase is further according to the respective likelihood of the intent associated with the training phrase. In a further embodiment of the first aspect, determining the respective likelihood of each intent comprises determining a respective rate of occurrence of each intent in the electronic user interface.

In an embodiment of the first aspect, the method further includes determining, for each of the plurality of user intents, a cumulative intent score by aggregating individual intent scores for the user intent, wherein outputting the plurality of user intents is according to cumulative intent scores.

In an embodiment of the first aspect, the method further includes determining that none of the individual intent scores exceeds a threshold, wherein the outputting the plurality of user intents is in response to determining that none of the individual intent scores exceeds the threshold. In a further embodiment of the first aspect, the user-generated text is first user-generated text and the individual intent scores are first individual intent scores, and the method further includes receiving, by the computing system, second user-generated text, the second user-generated text entered by a user through the electronic user interface, generating, by the computing system, third embeddings representative of the second user-generated text, calculating, by the computing system, a respective second individual intent score for each of the plurality of training phrases, each second individual intent score calculated according to a similarity of the third embeddings to the second embeddings, and determining that a second individual intent score of the plurality of second individual intent scores exceeds the threshold and, in response, classifying, a user intent for the second user-generated text as the intent associated with the second individual intent score that exceeds the threshold.

In an embodiment of the first aspect, the method further includes training a machine learning model according to a plurality of training data pairs to generate a trained machine learning model, each training data pair comprising a past user-generated text and an intent of the set of predefined user intents, wherein the past user-generated text was received through the electronic user interface. In a further embodiment of the first aspect, generating the first embeddings is by the trained machine learning model. In a further embodiment of the first aspect, the method further includes generating the second embeddings by the trained machine learning model.

In a second aspect of the present disclosure, a computing system is provided that includes a processor and a non-transitory, computer-readable medium containing instructions that, when executed by the processor, cause the computing system to perform operations for determining a user intent from a predefined set of user intents. The operations include receiving user-generated text, the user-generated text entered by a user through an electronic user interface, generating first embeddings representative of the user-generated text, calculating a respective individual intent score for each of a plurality of training phrases, each individual intent score calculated according to a similarity of the first embeddings to second embeddings, representative of a respective training phrase of the plurality of training phrases, wherein each training phrase is associated with an intent of the predefined set of user intents, outputting, to the user in response to the user-generated text, a plurality of user intents according to the respective individual intent scores, receiving, from the user, a selection of one of the plurality of user intents, and classifying, according to the selection, a user intent for the user-generated text.

In an embodiment of the second aspect, the operations further include determining a respective likelihood of each intent of the predefined set of user intents, wherein calculating the respective intent score for each training phrase is further according to the respective likelihood of the intent associated with the training phrase. In a further embodiment of the second aspect, determining the respective likelihood of each intent comprises determining a respective rate of occurrence of each intent in the electronic user interface.

In an embodiment of the second aspect, the operations further include determining, for each of the plurality of user intents, a cumulative intent score by aggregating individual intent scores for the user intent, wherein outputting the plurality of user intents is according to cumulative intent scores.

In an embodiment of the second aspect, the operations further include determining that none of the individual intent scores exceeds a threshold, wherein the outputting the plurality of user intents is in response to determining that none of the individual intent scores exceeds the threshold. In a further embodiment of the second aspect, the user-generated text is first user-generated text and the individual intent scores are first individual intent scores, and the operations further include receiving second user-generated text, the second user-generated text entered by a user through the electronic user interface, generating third embeddings representative of the second user-generated text, calculating a respective second individual intent score for each of the plurality of training phrases, each second individual intent score calculated according to a similarity of the third embeddings to the second embeddings, and determining that a second individual intent score of the plurality of second individual intent scores exceeds the threshold and, in response, classifying, a user intent for the second user-generated text as the intent associated with the second individual intent score that exceeds the threshold.

In an embodiment of the second aspect, the operations further include training a machine learning model according to a plurality of training data pairs to generate a trained machine learning model, each training data pair comprising a past user-generated text and an intent of the set of predefined user intents, wherein the past user-generated text was received through the electronic user interface. In a further embodiment of the second aspect, generating the first embeddings is by the trained machine learning model. In a further embodiment of the second aspect, the operations further include generating the second embeddings by the trained machine learning model.

In a third aspect of the present disclosure, a computer-implemented method of determining a user intent from a predefined set of user intents is provided. The method includes receiving, by a computing system, user-generated text, the user-generated text entered by a user through an electronic user interface, generating, by the computing system, first embeddings representative of the user-generated text, calculating, by the computing system, a respective cumulative intent score for each of a plurality of intents of the set of predefined user intents, each cumulative intent score calculated according to a cumulative similarity of the first embeddings to second embeddings representative a plurality of training phrases, wherein each training phrase is associated with an intent of the predefined set of user intents, and classifying, according to the cumulative intent scores, a user intent for the user-generated text.

In an embodiment of the third aspect, the method further includes determining, by the computing system, a respective likelihood of each intent of the predefined set of user intents, wherein calculating the respective intent score for each training phrase is further according to the respective likelihood of the intent associated with the training phrase.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method of determining a user intent from a predefined set of user intents, the method comprising:
receiving, by a computing system, user-generated text, the user-generated text entered by a user through an electronic user interface;
generating, by the computing system, first embeddings representative of the user-generated text;
calculating, by the computing system, a respective individual intent score for each of a plurality of training phrases, each individual intent score calculated according to a similarity of the first embeddings to second embeddings, representative of a respective training phrase of the plurality of training phrases, wherein each training phrase is associated with an intent of the predefined set of user intents;
outputting, to the user in response to the user-generated text, a plurality of user intents according to the respective individual intent scores;
receiving, from the user, a selection of one of the plurality of user intents; and
classifying, according to the selection, a user intent for the user-generated text.

2. The method of claim 1, further comprising:
determining, by the computing system, a respective likelihood of each intent of the predefined set of user intents;
wherein calculating the respective intent score for each training phrase is further according to the respective likelihood of the intent associated with the training phrase.

3. The method of claim 2, wherein determining the respective likelihood of each intent comprises determining a respective rate of occurrence of each intent in the electronic user interface.

4. The method of claim 1, further comprising:
determining, for each of the plurality of user intents, a cumulative intent score by aggregating individual intent scores for the user intent;
wherein outputting the plurality of user intents is according to cumulative intent scores.

5. The method of claim 1, further comprising:
determining that none of the individual intent scores exceeds a threshold;
wherein the outputting the plurality of user intents is in response to determining that none of the individual intent scores exceeds the threshold.

6. The method of claim 5, wherein the user-generated text is first user-generated text and the individual intent scores are first individual intent scores, the method further comprising:
receiving, by the computing system, second user-generated text, the second user-generated text entered by a user through the electronic user interface;
generating, by the computing system, third embeddings representative of the second user-generated text;
calculating, by the computing system, a respective second individual intent score for each of the plurality of training phrases, each second individual intent score calculated according to a similarity of the third embeddings to the second embeddings; and
determining that a second individual intent score of the plurality of second individual intent scores exceeds the threshold and, in response, classifying, a user intent for the second user-generated text as the intent associated with the second individual intent score that exceeds the threshold.

7. The method of claim 1, further comprising:
training a machine learning model according to a plurality of training data pairs to generate a trained machine learning model, each training data pair comprising a past user-generated text and an intent of the set of predefined user intents;
wherein the past user-generated text was received through the electronic user interface.

8. The method of claim 7, wherein generating the first embeddings is by the trained machine learning model.

9. The method of claim 8, further comprising:
generating the second embeddings by the trained machine learning model.

10. A computing system comprising:
a processor; and
a non-transitory, computer-readable medium containing instructions that, when executed by the processor, cause the computing system to perform operations for determining a user intent from a predefined set of user intents, the operations comprising:
receiving user-generated text, the user-generated text entered by a user through an electronic user interface;
generating first embeddings representative of the user-generated text;
calculating a respective individual intent score for each of a plurality of training phrases, each individual intent score calculated according to a similarity of the first embeddings to second embeddings, representative of a respective training phrase of the plurality of training phrases, wherein each training phrase is associated with an intent of the predefined set of user intents;
outputting, to the user in response to the user-generated text, a plurality of user intents according to the respective individual intent scores;
receiving, from the user, a selection of one of the plurality of user intents; and
classifying, according to the selection, a user intent for the user-generated text.

11. The computing system of claim 10, wherein the operations further comprise:
determining a respective likelihood of each intent of the predefined set of user intents;
wherein calculating the respective intent score for each training phrase is further according to the respective likelihood of the intent associated with the training phrase.

12. The computing system of claim 11, wherein determining the respective likelihood of each intent comprises determining a respective rate of occurrence of each intent in the electronic user interface.

13. The computing system of claim 10, wherein the operations further comprise:
determining, for each of the plurality of user intents, a cumulative intent score by aggregating individual intent scores for the user intent;
wherein outputting the plurality of user intents is according to cumulative intent scores.

14. The computing system of claim 10, wherein the operations further comprise:
determining that none of the individual intent scores exceeds a threshold;
wherein the outputting the plurality of user intents is in response to determining that none of the individual intent scores exceeds the threshold.

15. The computing system of claim 14, wherein the user-generated text is first user-generated text and the individual intent scores are first individual intent scores, the operations further comprising:
receiving second user-generated text, the second user-generated text entered by a user through the electronic user interface;
generating third embeddings representative of the second user-generated text;
calculating a respective second individual intent score for each of the plurality of training phrases, each second individual intent score calculated according to a similarity of the third embeddings to the second embeddings; and
determining that a second individual intent score of the plurality of second individual intent scores exceeds the threshold and, in response, classifying, a user intent for the second user-generated text as the intent associated with the second individual intent score that exceeds the threshold.

16. The computing system of claim 10, wherein the operations further comprise:
training a machine learning model according to a plurality of training data pairs to generate a trained machine learning model, each training data pair comprising a past user-generated text and an intent of the set of predefined user intents;
wherein the past user-generated text was received through the electronic user interface.

17. The computing system of claim 16, wherein generating the first embeddings is by the trained machine learning model.

18. The computing system of claim 17, wherein the operations further comprise:
generating the second embeddings by the trained machine learning model.

19. A computer-implemented method of determining a user intent from a predefined set of user intents, comprising:
receiving, by a computing system, user-generated text, the user-generated text entered by a user through an electronic user interface;
generating, by the computing system, first embeddings representative of the user-generated text;
calculating, by the computing system, a respective cumulative intent score for each of a plurality of intents of the set of predefined user intents, each cumulative intent score calculated according to a cumulative similarity of the first embeddings to second embeddings representative a plurality of training phrases, wherein each training phrase is associated with an intent of the predefined set of user intents; and
classifying, according to the cumulative intent scores, a user intent for the user-generated text.

20. The method of claim 19, further comprising:
determining, by the computing system, a respective likelihood of each intent of the predefined set of user intents;
wherein calculating the respective intent score for each training phrase is further according to the respective likelihood of the intent associated with the training phrase.
